(19) United States
(12) Patent Application Publication
(10) Pub. No.: US 2023/0187943 A1
(43) Pub. Date: Jun. 15, 2023

(54) METHOD FOR CONTROLLING AN ACTIVE RECTIFIER OF A WIND POWER INSTALLATION

(71) Applicant: Wobben Properties GmbH, Aurich (DE)

(72) Inventors: Roberto Rosso, Aurich (DE); Johannes Warsinski, Unterschleißheim (DE)

(21) Appl. No.: 18/063,371

(22) Filed: Dec. 8, 2022

(30) Foreign Application Priority Data
Dec. 9, 2021 (EP) 21213468.8
Aug. 24, 2022 (EP) 22191998.8

(51) Int. Cl. H02J 3/46; H02J 3/38; H02M 7/12

(52) U.S. Cl. CPC H02J 3/46; H02J 3/381; H02M 7/12; H02J 2300/28

(57) ABSTRACT

A method for controlling a converter, preferably a generator-side active rectifier of a power converter of a wind power installation, comprising: specifying a target value for the converter; specifying a carrier signal for the converter; capturing an actual value; determining a distortion variable from the target value and the actual value; and determining driver signals for the converter on the basis of the distortion variable and the carrier signal.

### BACKGROUND

### Technical Field

The present disclosure relates to a method for controlling a converter, preferably a generator-side active rectifier of a power converter of a wind power installation.

### Description of the Related Art

In the field of electrical energy producers, in particular in wind power or photovoltaic installations, converters are usually used to produce power.

In this case, the converters are often in the form of so-called converter systems, that is to say a plurality of converters or converter modules (e.g., circuits) or converter submodules are interconnected, preferably in parallel, in particular in order to form a higher-power converter system.

In this case, the converters or the converter systems can be controlled by means of a wide variety of methods, for example by means of a hysteresis method, such as the tolerance band method, or by means of a modulation method, such as pulse width modulation.

The hysteresis methods are usually in the form of direct closed-loop current control methods with a closed control loop and have a fast dynamic response and a high degree of robustness with, in particular, a non-linear closed-loop control behavior and broadband noise.

The modulation methods usually have a fixed clock frequency, resulting in harmonics at a multiple of the modulation frequency which are often in the audible range. In contrast, selecting accordingly higher modulation frequencies results in problems with electromagnetic compatibility (for short: EMC) and in higher loads inside the converters or converter systems.

Previously known methods have the disadvantage, in particular, of the broadband noise, on the one hand, and the lack of a dynamic response and audible harmonics, on the other hand.

### BRIEF SUMMARY

Provided is a method for controlling converters, in particular active rectifiers of a wind power installation, which method has only little current ripple in the generator and therefore results in low force fluctuations in the air gap of the generator and in less noise.

Provided is a method for controlling a converter, preferably a generator-side active rectifier of a power converter of a wind power installation, comprising the steps of: specifying a target value for the converter; specifying a carrier signal for the converter; capturing an actual value; determining a distortion variable from the target value and the actual value; and determining driver signals for the converter on the basis of the distortion variable and the carrier signal.

In particular, a method for controlling an active rectifier of a wind power installation is therefore proposed, which method determines the driver signals for the active rectifier, in particular directly, from a measurement error, preferably without calculating additional target voltage values in the process, as in the case of conventional pulse width modulations (PWM), for example.

The proposed method has the advantage, in particular, that general system parameters are not absolutely necessary since the driver signals are preferably determined from a measurement error. This means that the proposed method can be parameterized and implemented more easily than previously known PWM methods, for example.

According to one embodiment, a target value and a signal, in particular an additional signal, are first of all specified for the converter.

The target value is preferably a target specification for a physical variable, for example a current to be generated by the converter. The target value is preferably a target current value for an alternating current to be generated by an active rectifier, for example in the form of a value or a function.

The, in particular additional, carrier signal is, for example, a comparison signal or a ramp signal. The carrier signal is preferably a triangular signal. In this case, the carrier signal is used, in particular, for a comparison, preferably in order to determine the driver signals for the converter, for example as shown in FIG. 6.

More preferably, the amplitude and/or the frequency and/or the period and/or the width of the carrier signal can be set. The amplitude and/or the frequency and/or the period and/or the width of the carrier signal is/are particularly preferably varied during ongoing operation, in particular in order to produce so-called smearing of the frequency band.

The frequency of the carrier signal is preferably selected on the basis of structural dynamic designs, for example in order to minimize the effects on the noise emissions of a corresponding generator. If the method described herein is used, for example, to control an active rectifier which is connected to a generator, the carrier signal preferably has a frequency of between 200 Hz (Hertz) and 2500 Hz, more preferably between 500 Hz and 1500 Hz.

In a further step, an actual value is then captured and compared with the target value, in particular in order to determine a distortion variable.

The actual value is preferably a physical variable which corresponds, in particular, to the target value, for example the current generated by the converter. The actual value is preferably an actual current value, in particular of an alternating current generated by an active rectifier.

The distortion variable determined from the target value and the actual value, for example by means of a difference, can also be referred to as a measurement or closed-loop control error.

The method therefore has at least one control loop and is preferably in the form of a direct closed-loop current control method, in particular in order to generate a three-phase alternating current for a stator of a generator of a wind power installation.

In this case, the distortion variable is preferably formed from a difference between the target value and the actual value and, if the target value and the actual value represent a current, can also be referred to as a distortion current.

The distortion variable may therefore likewise be a value or a function; in particular, the distortion variable is a differential current which varies over time and represents a difference between the target current and the actual current of a converter, in particular an active rectifier.

The driver signals for the converter, in particular for the switches of the converter, preferably the switches of the active rectifier, are then determined from the distortion variable and the carrier signal. If the active rectifier is, for example, in the form of a B6C rectifier having six switches, in particular circuit breakers, six driver signals are then accordingly determined, one driver signal for each switch.

The driver signals may be determined, for example, by comparing the distortion variable with the carrier signal. For this purpose, the distortion variable is integrated to form a modulation signal and is compared with the carrier signal, for example, wherein the points of intersection between the modulation signal and the carrier signal form a trigger for generating a corresponding driver signal.

It is therefore proposed, in particular, that the driver signals are generated by comparing the distortion variable and/or an extended distortion variable and/or a modulation signal with the carrier signal.

If the carrier signal is a ramp signal, for example, the method is in the form of a so-called ramp comparison method (ramp comparison control).

The driver signals are therefore used, in particular, to switch the switches of the converter, in particular the switches of the active rectifier, preferably in order to generate an electrical alternating current in the stator of the generator of the wind power installation, which current corresponds substantially to the target value, that is to say a target current.

The method described herein therefore preferably also comprises the step of: switching at least one switch of the converter, in particular of the active rectifier, on the basis of the driver signals, in particular in such a manner that the converter, in particular the active rectifier, generates an electrical alternating current in the stator of the generator of the wind power installation, which current corresponds substantially to the target value.

The method described herein may be designed both with and without hysteresis in this case. The method described herein is preferably designed without hysteresis.

The method described herein makes it possible, in particular, to improve the current quality of a converter, in particular of an active rectifier.

If the method described herein is used for a generator-side active rectifier, the quality of the stator current of the generator can be considerably improved, thus reducing the noise emissions of the generator.

The distortion variable is preferably determined taking into account a closed-loop control difference and/or a database.

The distortion variable is therefore based, in particular, on a closed-loop control difference, for example between a target value and an actual value, or on a lookup table, as described herein.

Alternatively or additionally, the distortion variable may also be amplified, for example by a factor of between 2 and 10, in particular in order to improve the signal quality. In this case, the gain is preferably set on the basis of the electrical phase section of the wind power installation, for example on the basis of a stator inductance or a stator resistance.

Alternatively or additionally, a corresponding system state and/or an operating point of the converter and/or of a generator and/or of a wind power installation can also be taken into account, in particular in order to determine the distortion variable, for example by means of a model, a special filter or the database described herein.

The driver signals are then preferably accordingly determined on the basis of the distortion variable and/or a modulation signal and the carrier signal.

It is therefore also proposed, in particular, that the driver signals are generated by means of comparison with the carrier signal, for example as shown in FIG. 6.

Alternatively or additionally, the driver signals are determined on the basis of an offset which takes into account an operating point of the converter, in particular, for example by means of a database in the form of a lookup table.

It is therefore also proposed to alternatively or additionally take into account at least one operating point of the active rectifier and/or of the wind power installation, in particular by means of an offset and/or a database.

The offset may be, for example, in the form of a compensation value, such as a compensation current, which takes into account an operating point of the active rectifier and/or of the wind power installation.

The offset is preferably determined off-line, for example by means of simulation or calculation, and is accordingly set in a control unit (e.g., controller) or stored in a corresponding database for the control unit.

The steady-state error can be minimized or eliminated by appropriately accurate selection of the offset.

This makes it possible to increase the accuracy of the proposed method, in particular.

The target value is preferably a target current value, in particular for a current of an electrical (stator) system of a generator of a wind power installation.

The method is therefore designed, in particular, as closed-loop current control, preferably for a generator-side active rectifier of a wind power installation.

The driver signals are also preferably determined on the basis of a target current value, in particular for an active rectifier.

The carrier signal for the converter is preferably for setting a single-phase current, preferably of an electrical (stator) system of a generator of a wind power installation.

It is therefore also proposed, in particular, that the method described herein is used to set the stator currents of a generator, in particular of a wind power installation, preferably individually.

In this case, it is proposed, in particular, to individually set each phase of a (stator) system of the generator.

For example, the distortion current is individually determined for each phase and is compared with the signal in order to accordingly individually determine the driver signals for each phase. The distortion current is preferably present in abc coordinates for this purpose.

The carrier signal is preferably generated by a signal generator and has at least one of the following forms: triangular, sinusoidal, square-wave.

The signal for determining the driver signals is therefore preferably generated by a signal generator, for example as a triangular or sawtooth function.

For example, the triangular function has two symmetrical edges. The edges rise, for example, with an angle of between 30° and 60°, preferably between 40° and 50°, more preferably approximately 45°.

However, the triangular function may also be asymmetrical; for example, the rising edge has an angle of approximately 45° and the falling edge has an angle of approximately 60°.

The sawtooth function has at least one edge of 90°, for example the rising edge or the falling edge. The other edge then has, for example, an angle of between 30° and 60°, preferably between 40° and 50°, more preferably approximately 45°. The control variable is then compared with this carrier signal in order to generate the driver signals.

The method described herein is therefore preferably designed like or as a ramp comparison method, preferably with a triangle.

The carrier signal preferably has an amplitude and a frequency.

The distortion variable and/or the extended distortion variable and/or the modulation signal preferably has/have an amplitude and a frequency lower than the amplitude and/or the frequency of the carrier signal, in particular.

For example, the amplitude of the carrier signal is twice as large as the amplitude of the distortion variable.

It is therefore proposed, in particular, that the carrier signal has a larger amplitude than the amplitude of the signal with which it is compared, that is to say the distortion variable or the extended distortion variable or the modulation signal, for example.

In another embodiment, the amplitude of the carrier signal is normalized to 1, and the amplitudes of the signal with which it is compared are lower.

Alternatively or additionally, the amplitude of the carrier signal is constant or is varied.

Alternatively or additionally, it is also proposed that the carrier signal has a frequency, for example between 200 Hz and 2500 Hz, which is greater than the frequency of the signal with which it is compared, that is to say the distortion variable or the extended distortion variable or the modulation signal, for example.

The distortion variable has, for example, a frequency of between 10 Hz and 200 Hz, for example around 50 Hz or 60 Hz.

The actual value is preferably an actual current value, in particular for a current of an electrical (stator) system of a generator of a wind power installation.

For this purpose, the actual current value is preferably captured at the input of the converter, in particular at the input of the active rectifier, in particular as a three-phase alternating current.

The actual current value may be captured, for example, for an entire system, for example a three-phase stator system, as a total current and/or may be captured individually for each phase of the system.

The actual current value is preferably transformed or converted into abc coordinates. In order to also compare the actual current value with the target current value, the target current value is preferably transformed into abc coordinates and compared with the abc coordinates of the actual current value.

The actual value preferably comprises both a three-phase overall system and each phase of the overall system.

It is therefore also proposed, in particular, that the method takes into account both the entire three-phase (stator) system and each phase of this system individually.

This can be carried out, for example, by carrying out both a comparison in the overall system and a comparison in each phase. For this purpose, for example, the actual value can be compared with a target value in d/q coordinates and additionally or subsequently again in abc coordinates.

For this purpose, the overall system is preferably captured as a sum current in d/q coordinates.

The target value and/or the distortion variable and/or a compensation value and/or an offset, in particular from a database, is/are or is/are preferably present in d/q coordinates.

It is therefore proposed, in particular, to carry out the method described herein at least partially in d/q coordinates, in particular in order to take into account the entire (stator) system. In particular, at least the overall system is taken into account as a sum current in d/q coordinates.

It is also proposed that at least one compensation value and/or an offset is/are used to determine the driver signals for the converter. The compensation value may be determined, for example, by way of a closed-loop control difference between the target value and the actual value. The compensation value is preferably determined by way of a closed-loop control operation. In contrast, the offset may be stored in a database, for example. In this case, the offset is preferably provided by means of a controller.

In this case, the compensation value and the offset have substantially the same function, specifically that of taking into account an operating point and/or a system state of the converter and/or of the generator and/or of the wind power installation.

The compensation value and/or the offset is/are preferably current value, in particular in d/q coordinates, in particular for a stator current of a converter of a wind power installation.

In addition, a further part of the method described herein may also be carried out in abc coordinates, in particular in order to take into account the individual phases of the (stator) system.

The actual value or actual current value is preferably present in abc coordinates.

Transforming the actual and target values into d/q coordinates makes it possible, on the one hand, to considerably simplify the method and, on the other hand, to use a closed-loop controller to control the converter, in particular the active rectifier, which does not have any steady-state error, in particular.

However, the comparison with the carrier signal is preferably carried out in abc coordinates.

The method described herein is preferably carried out for a first electrical (stator) system of a generator of a wind power installation using a first carrier signal and is likewise carried out in a parallel manner, in particular at the same time, for a second electrical (stator) system of the same generator using a second carrier signal, wherein the first carrier signal and the second carrier signal are substantially identical, but are offset with a phase angle with respect to one another, wherein the phase angle is, in particular, between 30° and 120°, preferably between 80° and 100°, in particular around approximately 90°.

It is therefore proposed, in particular, to use the method described herein for a generator of a wind power installation having two (stator) systems which are offset by 30°, for example, and are each connected to an active rectifier, wherein the active rectifiers are operated at the same time using the method described herein, in particular using substantially identical carrier signals which have a phase offset with respect to one another, however.

In the case of parallel (stator) systems, the method is therefore carried out, in particular, with a phase offset in the carrier signal.

It was recognized that a phase offset of approximately 90°, in particular, results in low-noise operation in the case of two parallel (stator) systems.

The carrier signal is preferably varied during ongoing operation, in particular by means of a ramp function on the basis of the rotor speed of the generator of the wind power installation, for example by a value in a range between 0 and 10 percent, preferably approximately 5 percent.

It is therefore also proposed, in particular, not to use a constant carrier signal, but rather to change the carrier signal for determining the driver signals during ongoing operation, preferably on the basis of a rotor speed of the generator.

The amplitude and/or the frequency and/or the period and/or the width is/are particularly preferably varied during ongoing operation, in particular in order to produce so-called smearing of the frequency band.

For example, the carrier signal has a variable frequency which is varied using a ramp function, for example around a particular frequency, in particular with a period duration that is proportional, in particular indirectly proportional, to the number of pole pairs and/or the rotor speed of the generator.

This makes it possible, in particular, to reduce any harmonics in the alternating current, in particular such that smaller or no filters at all are needed to ensure low-noise generator operation.

In one example, the frequency of the carrier signal is between 500 Hz and 2500 Hz, for example 700 Hz, and is varied by approximately 5 percent, that is to say 35 Hz.

Provided is a method for controlling a wind power installation, comprising the steps of: operating a converter of the wind power installation in a first operating mode; and operating the converter of the wind power installation in a second operating mode, wherein the converter is operated in the second operating mode using a method for controlling a converter, in particular as described herein.

It is therefore proposed, in particular, that the method for controlling a converter, as described herein, is used in a wind power installation, in particular in the form of an operating mode and/or as part of a particular operating mode of the wind power installation.

The method for controlling a converter, as described herein, is preferably used only in particular situations or scenarios, for example at night or the like, in particular when the noise emissions of the wind power installation must be reduced and/or changed.

In the first operating mode, the wind power installation is preferably operated in a normal or power-optimized manner. This means, in particular, that the wind power installation generates a maximum possible (active) power. The converter preferably operates in the first operating mode using a tolerance band method, that is to say the converter generates the current to be fed in using a tolerance band. In this case, the tolerance band method preferably has constant band limits, that is to say a constant upper band limit and a constant lower band limit. In this case, the band limits are deliberately kept constant or even over a particular time, in particular. The first operating mode can also be referred to as a normal operating mode. In the first operating mode, the wind power installation is, in particular, not operated using a method for controlling a converter, as described herein, but rather using a different method.

In the second operating mode, the wind power installation is operated, in particular, in a noise-reduced or noise-optimized manner. This means, in particular, that the wind power installation must not exceed or does not exceed a particular acoustic limit value. In the second operating mode, the converter operates, in particular, using a method as described herein, that is to say, in particular, using a carrier signal which results, in particular, in modulated and preferably non-constant band limits. In the second operating mode, the wind power installation preferably generates a maximum possible (active) power taking into account a limit value of an acoustic variable, in particular a maximum permitted noise level of the wind power installation and/or of the generator.

The changeover from the first operating mode to the second operating mode is preferably carried out in multiple stages and/or using an intermediate mode. For example, for the changeover, use is initially made of a first carrier signal which results in first modulation of the current and/or of the band limits that is lower than the modulation using the second carrier signal which is for the second operating mode. In the intermediate mode, the converter is therefore first operated using a first carrier signal and/or using a first modulated band limit for a predetermined time, for example, and is then operated using a second carrier signal and/or using a second modulated band limit. The intermediate mode may also be part of the second operating mode. The intermediate mode is intended to enable, in particular, a soft or smooth changeover between the first operating mode and the second operating mode. The intermediate mode preferably lasts for a predetermined transition time which is shorter than 10 minutes, preferably shorter than 5 minutes.

The changeover from the first operating mode to the second operating mode is preferably carried out, preferably only carried out, when the wind power installation and/or the generator has/have an acoustic variable which is above a predetermined limit value.

It is therefore also proposed, in particular, that the wind power installation changes over to a noise-reduced or noise-optimized mode only when a predetermined limit value for an acoustic variable has been exceeded.

Alternatively and/or additionally, the changeover from the first operating mode to the second operating mode is carried out, preferably only carried out, when a wind power installation control unit (e.g., controller) specifies this.

The wind power installation comprises, for example, a daytime/nighttime mode and, in the nighttime mode, the converter of the wind power installation is operated using a method for controlling a converter, as described herein. However, other scenarios are also possible, for example because the wind power installation operator, the wind farm operator or the network operator desires a corresponding noise-reduced mode.

Provided is a method for controlling a wind power installation, comprising the steps of: operating a converter of the wind power installation in an, in particular second, operating mode, wherein the converter is operated in the second operating mode using a method described herein and/or using a database described herein.

It is therefore proposed, in particular, that the method for controlling a converter, as described herein, is used in a wind power installation, in particular using a database, preferably a lookup table. In this case, the database comprises, in particular, information that takes into account different operating points of the generator and/or of the converter and/or of the wind power installation, for example the rotor speed, target stator current, rotor position or the like.

The database is therefore used, in particular, to control the converter and therefore the generator and the wind power installation on the basis of an operating point.

In this case, the database preferably comprises quantities and/or variables and/or parameters and/or operating parameters which result, in particular, in fixed compensation within the controller described herein. The quantities and/or variables and/or parameters and/or operating parameters in the database can be determined, for example, by means of simulation and/or a test mode of the converter and/or of the wind power installation. The quantities and/or variables and/or parameters and/or operating parameters can therefore be understood as meaning a determined and/or calculated offset. The quantities and/or variables and/or parameters and/or operating parameters in the database are determined in this case, in particular, in such a manner that the generator and/or the wind power installation emit(s) less and/or different noise or vibrations. The quantities and/or variables and/or parameters and/or operating parameters are therefore preferably noise-optimized.

It is therefore also proposed, in particular, that certain operating points are taken into account for the quantities and/or variables and/or parameters and/or operating parameters in the database.

The predetermined parameter and/or the precalculated offset is/are preferably for a certain operating point of an active rectifier and/or of the generator of the wind power installation.

The database or the predetermined parameters and/or the precalculated offset is/are preferably taken into account only when the wind power installation and/or the generator has/have an acoustic variable which is above a predetermined limit value.

It is therefore also proposed, in particular, that the wind power installation changes over to a noise-reduced or noise-optimized mode by means of the database only when a predetermined limit value for an acoustic variable has been exceeded.

Alternatively and/or additionally, the database or the predetermined parameters and/or the precalculated offset is/are only taken into account when a wind power installation control unit (e.g., controller) specifies this.

The wind power installation comprises, for example, a daytime/nighttime mode and, in the nighttime mode, the converter of the wind power installation is operated using a method for controlling a converter, as described herein. However, other scenarios are also possible, for example because the wind power installation operator, the wind farm operator or the network operator desires a corresponding mode.

Provided is a wind power installation comprising a converter and a control unit, wherein the converter is in the form of a power converter and is operated by means of the control unit using a method described herein.

The wind power installation is, for example, in the form of a buoyancy rotor with a horizontal axis of rotation and preferably has three rotor blades on an aerodynamic rotor on the windward side.

The electrical phase section of the wind power installation that is connected to the aerodynamic rotor comprises substantially a generator, a converter connected to the generator and a (network) connection connected to the converter in order to connect the wind power installation to an electrical wind farm network or an electrical supply network, for example.

The generator is preferably in the form of a synchronous generator, for example a separately excited synchronous generator or a permanently excited synchronous generator.

The converter is preferably in the form of a power converter. This means, in particular, that the converter is used to convert electrical power generated by the generator.

The converter is also preferably integrated in the wind power installation as a full converter. This means, in particular, that the entire electrical power generated by the generator is passed via the converter and is therefore converted by the latter.

The converter is preferably in the form of an AC converter, also referred to as an AC/AC converter. This means, in particular, that the converter has at least one rectifier and one inverter. The converter is particularly preferably in the form of a direct converter or as a converter with a DC voltage intermediate circuit. In one particularly preferred embodiment, the converter is in the form of a back-to-back converter.

The converter preferably has at least one generator-side active rectifier which is controlled by means of a control unit described herein and/or by means of a method described herein.

The generator preferably has two stator systems, in particular offset by 30°, which are each connected to an active rectifier and are each control separately from one another via a control unit.

In this case, the control units operate, in particular, with a method described herein, wherein the methods have, in particular, a phase offset in the carrier signal, for example of approximately 90°.

The control unit preferably has at least a first operating mode and a second operating mode, in particular as described herein.

The control unit is preferably configured to change over from the first operating mode to the second operating mode, in particular if the generator and/or the wind power installation exceed(s) a predetermined limit value, in particular an acoustic limit value, and a change in the operating mode is specified, for example by a network operator, a wind farm operator, a daytime/nighttime change of the like.

The control unit preferably comprises at least one database described herein and/or is connected to a database described herein.

### BRIEF DESCRIPTION OF THE SEVERAL VIEWS OF THE DRAWINGS

The present disclosure is explained in more detail below on the basis of the accompanying figures, wherein the same reference signs are used for identical or similar components or assemblies.

FIG. 1 schematically shows, by way of example, a perspective view of a wind power installation in one embodiment.

FIG. 2 schematically shows, by way of example, a structure of an electrical phase section of a wind power installation in one embodiment.

FIG. 3 schematically shows, by way of example, the structure of a converter.

FIG. 4A schematically shows, by way of example, the structure of a control unit (e.g., controller) of a converter in one embodiment.

FIG. 4B schematically shows, by way of example, the structure of a control unit (e.g., controller) of a converter in a further preferred embodiment.

FIG. 4C schematically shows, by way of example, a control module (e.g., control circuit) of a control unit (e.g., controller) for varying a frequency of the signal.

FIG. 5 schematically shows, by way of example, the sequence of a method for controlling a converter in one embodiment.

FIG. 6 schematically shows, by way of example, determination of a driver signal for the converter on the basis of the distortion variable and the carrier signal.

### DETAILED DESCRIPTION

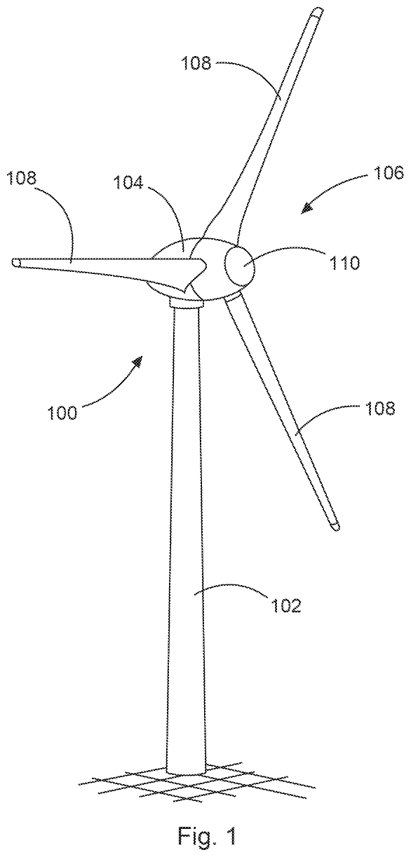

FIG. 1 schematically shows, by way of example, a perspective view of a wind power installation 100.

The wind power installation 100 is in the form of a buoyancy rotor with a horizontal axis and three rotor blades 200 on the windward side, in particular as horizontal rotors.

The wind power installation 100 has a tower 102 and a nacelle 104.

An aerodynamic rotor 106 with a hub 110 is arranged on the nacelle 104.

Preferably exactly three rotor blades 108 are arranged on the hub 110, in particular in a symmetrical manner with respect to the hub 110, preferably in a manner offset by 120°.

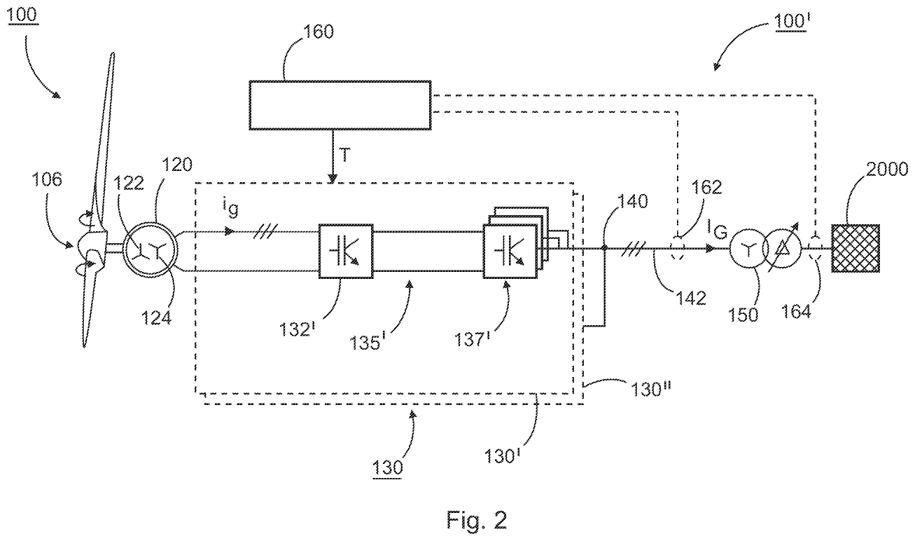

FIG. 2 schematically shows, by way of example, an electrical phase section 100′ of a wind power installation 100, as preferably shown in FIG. 1.

The wind power installation 100 has an aerodynamic rotor 106 which is mechanically connected to a generator 120 of the wind power installation 100.

The generator 120 is preferably in the form of a 6-phase synchronous generator, in particular with two three-phase systems 122, 124 which are phase-shifted through 30° and are decoupled from one another.

The generator 120 is connected to an electrical supply network 2000 or is connected to the electrical supply network 2000 via a converter 130 and by means of a transformer 150.

In order to convert the electrical power generated by the generator 120 into a current iG to be fed in, the converter 130 has in each case at least one converter module (e.g. converter circuit 130′, 130″ for each of the electrical systems 122, 124, wherein the converter modules 130′, 130″ are substantially structurally identical.

The converter modules 130′, 130″ have an active rectifier 132′ at a converter module input. The active rectifier 132′ is electrically connected to an inverter 137′, for example via a DC voltage line 135′ or a DC voltage intermediate circuit.

The converter 130 or the converter modules 130′, 130″ is/are preferably in the form of (a) direct converter(s) (back-to-back converter).

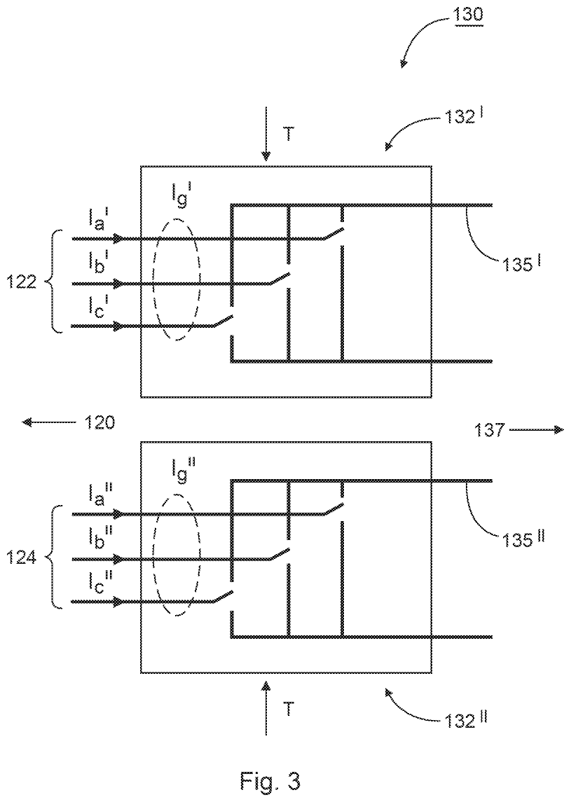

The method of operation of the active rectifiers 132′, 132″ of the converter 130 and the control thereof are explained in more detail in FIG. 3, in particular.

The two electrically three-phase systems 122, 124 which are decoupled from one another on the stator side are combined, for example on the network side, at a node 140 to form a three-phase overall system 142 which carries the total current iG to be fed in.

In order to feed the total current iG to be fed in into the electrical supply network 2000, a wind power installation transformer 150 is also provided at the output of the wind power installation, which transformer is preferably star-delta connected and connects the wind power installation 100 to the electrical supply network 2000.

The electrical supply network 2000, to which the wind power installation 100, 100′ is connected by means of the transformer 150, may be, for example, a wind farm network or an electrical supply or distribution network.

In order to control the wind power installation 100 or the electrical phase section 100′, a wind power installation control unit 160 (e.g., controller) is also provided.

In this case, the wind power installation control unit 160 is configured, in particular, to set a total current iG to be fed in, in particular by controlling the active rectifiers 132′, 132″ or inverters 137′, 137″.

In this case, the active rectifiers 132′, 132″ are controlled, in particular, as described herein, preferably by means of or on the basis of the driver signals T.

The wind power installation control unit 160 is preferably also configured to capture the total current iG using a current capture means 162. The currents of each converter module 137′ in each phase are preferably captured for this purpose, in particular.

In addition, the control unit also has voltage capture means 164 which are configured to capture a network voltage, in particular of the electrical supply network 2000.

In one particularly preferred embodiment, the wind power installation control unit 160 is also configured to also capture the phase angle and the amplitude of the current iG to be fed in.

The wind power installation control unit 160 also comprises a control unit 1000, described herein, for the converter 130.

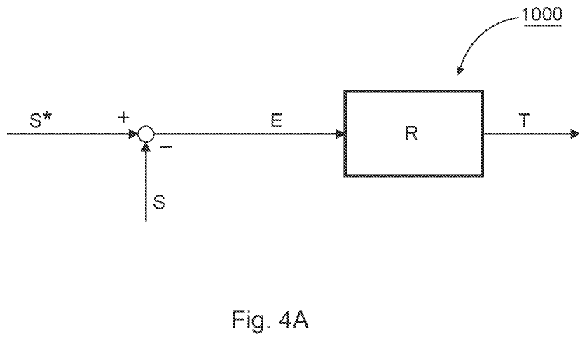

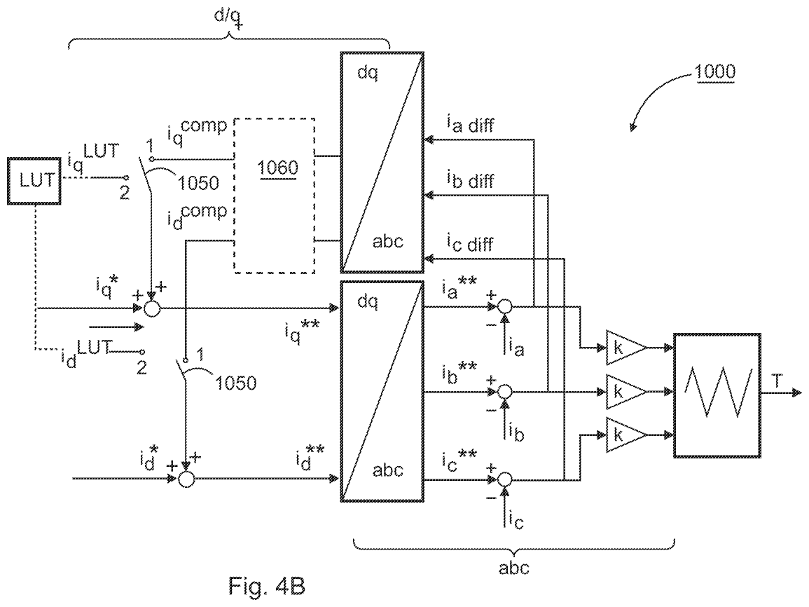

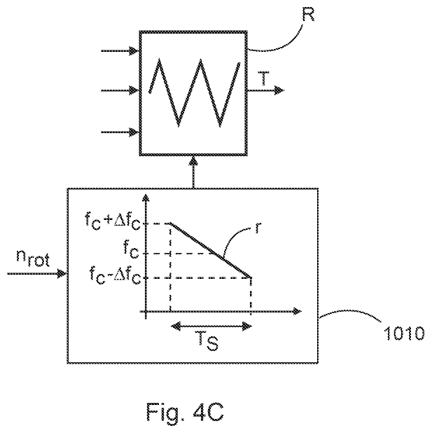

The control unit 1000 is therefore configured, in particular, to control the entire converter 130 with its two converter modules 130′, 130″, in particular as shown in FIG. 4, using driver signals T.

FIG. 3 schematically shows, by way of example, the structure of a converter 130, in particular of active rectifiers 132′, 132″, as shown in FIG. 2.

In this case, the converter 130 comprises, in particular, two active rectifiers 132′, 132″:
a first active rectifier 132′ for a or the first electrically three-phase system 122 and a second active rectifier 132″ for a or the second electrically three-phase system 124.

The active rectifiers 132′, 132″ are each connected, on the generator side, to a system 122, 124 of a or the generator 120 and are connected to an inverter 137′, 137″ via a DC voltage 135′, 135″, for example, as shown in FIG. 2, in particular.

The active rectifiers 132′, 132″ are each controlled using drive signals T by means of the control unit 1000 described herein and/or by means of a method described herein, in particular in order to respectively inject a three-phase alternating current ia′, ib′, ic′, ia″, ib″, ic″ in the stator of the generator 120.

FIG. 4A schematically shows, by way of example, the structure of a control unit 1000 of a converter 130, in particular for an active rectifier 132′, 132″.

The control unit 1000 determines a distortion variable E from a target value S* and an actual value S.

The target value S* and the actual value S are preferably physical variables of the converter, for example an alternating current to be generated by the active rectifier 132′, 132″.

The distortion variable E is determined from the target value and the actual value, preferably by means of a difference. The distortion variable can therefore also be referred to as a closed-loop control error or measurement error. If the target value S* is a target current and the actual value S is an actual current, the distortion variable E can also be referred to as a distortion current. The difference is preferably determined from abc coordinates, in particular as shown in FIG. 4B.

The distortion variable E, in particular the distortion current, is compared with a signal R, for example a ramp signal, in order to generate the driver signals T for the converter 130, in particular the active rectifier 132′, 132″.

For example, the distortion variable E can be functionally compared with the carrier signal R in such a manner that each point of intersection between the distortion variable E and the carrier signal R is used as a trigger point for a driver signal T, in particular as shown in FIG. 6.

For this purpose, the carrier signal R may be, for example, in the form of a triangular signal, in particular with or without hysteresis.

The control unit 1000 is therefore in the form of a (ramp) comparison controller, in particular.

FIG. 4B schematically shows, by way of example, the structure of a control unit of a converter in a further preferred embodiment, in particular for an active rectifier 132′, 132″.

The control unit 1000 is constructed substantially as in FIG. 4A, wherein the target value S*, the compensation value i_compd, i_compq and the parameters i_{d}_LUT, i_{d}_LUT are present in d/q coordinates and the actual value S is present in abc coordinates.

The target value S* is a target current value i_{d}*, i_{q}* in d/q coordinates. The compensation value i id_comp, iq_comp is likewise a current value and is based on a closed-loop control difference i_{a_diff}, ib__{diff}, ic__{diff} and/or on a parameter i_{d}_LUT, i_{q}_LUT in a database LUT.

The d component of the target current id* and the q component of the target current iq* are first of all transformed into abc coordinates. A closed-loop control difference i_{a_diff}, ib__{diff}, ic__{diff} is then determined from the target currents iₐ**, i_{b}**, i_{c}**, transformed into abc coordinates, and the actual values iₐ, i_{b}, i_{c}, in particular for each coordinate a, b, c individually.

This closed-loop control difference id, ib__{diff}, ic__{diff} is transformed back into d/q coordinates in order to determine the compensation values id_comp, iq_comp therefrom. A filter 1060 is preferably used to determine the compensation values id_comp, iq_comp.

In one embodiment, the compensation values id_comp, iq_comp are used to convert the target values i_{d}*, i_{q}* into a distortion variable id**, iq**, which are transformed into abc coordinates and are used to determine the driver signals T using a carrier signal R.

In another embodiment, the parameters i_{d}_LUT, i_{q}_LUT in the database are used to convert the target values i_{d}*, i_{q}* into a distortion variable id**, iq**, which are transformed into abc coordinates and are used to determine the driver signals T using a carrier signal R.

The current iₐ, i_{b}, i_{c} generated by the active rectifier can be optimized, in particular noise-optimized, by means of the compensation values id_comp, iq_comp or the parameters i_{d}_LUT, i_{q}_LUT.

In one preferred embodiment, depending on the operating mode of the converter and/or the wind power installation, the control unit 1000 chooses between the compensation values id_comp, iq_comp and the parameters id_LUT, iq_LUT in the database LUT. For this purpose, the control unit 1000 has a closed-loop controller changeover means 1050, for example. The control unit 1000 therefore has both open-loop control based on a database LUT and closed-loop control based on a closed-loop control difference. Depending on the operating mode, the control unit can choose between open-loop control and closed-loop control.

The control variables id**, iq** represent, in particular, the total closed-loop control error of a (stator) system of the generator and are broken down into abc coordinates ia**, ib**, ic** corresponding to the phases a, b, c of the system and are compared with the actual currents ia, ib, ic of the respective phase a, b, c, are then possibly amplified and compared with a triangular signal R, in particular in order to determine the driver signals T for the switches of the active rectifier.

Each electrical system 122, 124 preferably has an active rectifier 132′, 132″ which is respectively controlled by a control unit 1000 described herein using the driver signals T.

FIG. 4C schematically shows, by way of example, a control module (e.g., control circuit) 1010 of a control unit (e.g., controller) 1000 for varying a frequency of the signal.

The control module 1010 is configured to change the frequency f_{R} of the signal R, for example in a predetermined frequency range Δf.

This can be carried out using a ramp r, for example.

The slope or rise of the ramp r is based in this case on the predetermined frequency range Δf and the period duration of the stator currents Tₛ, for example on the basis of the number of pole pairs p of the generator and/or the rotor speed nᵣₒₜ of the generator, preferably by means of

$${T}_{s} = \frac{60}{{n}_{r o t} * p} .$$

For example, if the rotor speed is approximately 7.7 rpm and the number of pole pairs of the generator is 57, the period duration of the stator currents is approximately 136.7 ms.

In one preferred embodiment, and if the generator has two (stator) systems, this frequency change or smearing is selected for both systems.

The frequency variation for smearing is, for example, 5% of the frequency of the carrier signal. If the carrier signal has a frequency of 700 Hz, for example, the frequency variation for smearing is 35 Hz.

It is therefore also proposed, in particular, to select the same smearing for a plurality of systems.

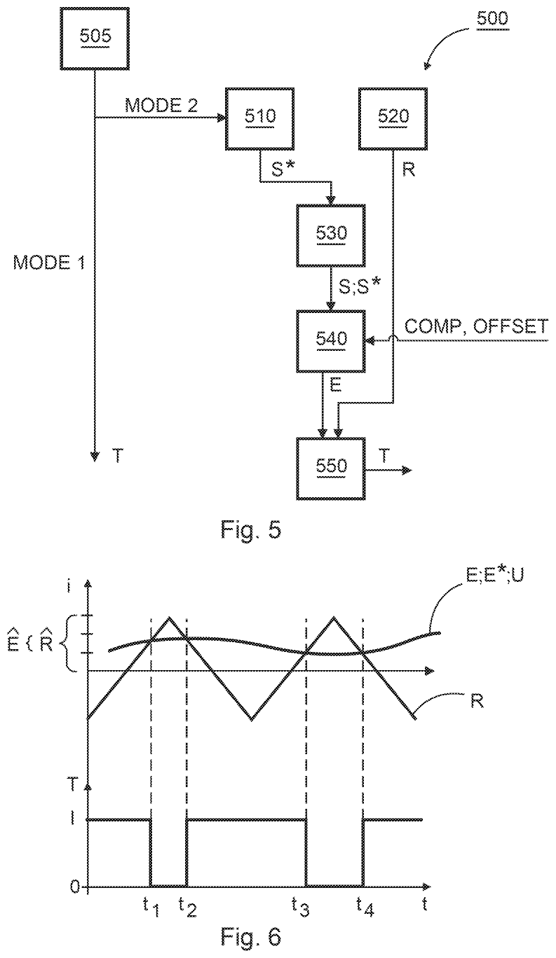

FIG. 5 schematically shows, by way of example, the sequence of a method 500 for controlling a converter 130, in particular an active rectifier 132′, 132″, in one embodiment.

The converter is first of all operated in a first operating mode MODE1, for example in a power-optimized operating mode MODE1. This is indicated by block 505.

If the wind power installation, for example, then exceeds a predetermined limit value for an acoustic variable, there is a changeover to a second operating mode MODE2, in particular as described herein.

The second operating mode MODE2 is noise-optimized, for example, and is designed, in particular, as described below.

In a first step 510 of the second operating mode MODE2, at least one target value S* is specified for the converter 130, preferably a target current value in d/q coordinates.

In addition, in a further step 520 of the second operating mode MODE2, a carrier signal R is specified for the converter 130, preferably a sawtooth signal.

In a further step 530 of the second operating mode MODE2, an actual value S is then captured, in particular an actual current value of the converter 130, preferably in abc coordinates.

In a further step 540, a distortion variable E is then determined from the target value S* specified in this manner and the actual value S captured in this manner, in particular as shown in FIGS. 4A and 4B. The distortion variable E is preferably determined using a compensation value COMP and/or an offset. The compensation value COMP is preferably determined by means of closed-loop control and the offset is specified by a database.

A driver signal T for the converter 130, and in particular for the switches of the converter 130, is determined from the distortion variable E determined in this manner and the signal R, for example by means of comparison. This is indicated by block 550.

FIG. 6 schematically shows, by way of example, determination of a driver signal T for the converter on the basis of the distortion variable E and the carrier signal R.

The carrier signal R is designed as described herein.

In particular, the carrier signal R has an amplitude R and a frequency fR.

The distortion variable E, for example, is compared with this carrier signal R in order to generate corresponding driver signals T.

The distortion variable E is likewise designed as described herein.

In particular, the distortion variable E has an amplitude E and a frequency fE.

For example, a carrier signal R in the form of a triangle and the distortion variable E are used to determine the driver signals T.

The carrier signal R has a frequency of approximately 700 Hz, for example. The distortion variable has a frequency of approximately 50 Hz, for example. In addition, the amplitude of the carrier signal is at least twice as large as the amplitude of the distortion variable.

If the present value of the distortion variable E is greater than the carrier signal R, the driver signal T is equal to 1 and accordingly a switch of the converter is at position 1, that is to say is switched on, for example.

If the distortion variable E, for example, then falls below the carrier signal R at the time t1, the driver signal T becomes equal to 0 and the corresponding switch of the converter is switched to position 0, that is to say is switched off, for example.

If the distortion variable E then exceeds the carrier signal R again at the time t2, the driver signal T becomes equal to 1 and the corresponding switch of the converter is switched to position 1 again.

A corresponding procedure then takes place at the times t3 and t4.

However, the driver signals T can also be accordingly determined using the extended distortion variable E* described herein or the modulation signal U described herein.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for controlling a generator-side active rectifier of a power converter of a wind power installation, comprising:
specifying a target value for the converter;
specifying a carrier signal for the converter;
receiving an actual value indicative of a current of an electrical system of the generator;
determining a distortion variable from the target value and the actual value; and
determining driver signals for the converter based on the distortion variable and the carrier signal.

2. The method according to claim 1, wherein determining the distortion variable takes into account a closed-loop control difference and/or a database.

3. The method according to claim 1, wherein determining the driver signals includes comparing the distortion variable and/or a modulation signal, which is based on the distortion variable, with the carrier signal.

4. The method according to claim 1, wherein determining the driver signals based on a precalculated offset, which takes an operating point into account.

5. The method according to claim 1, wherein the target value is a target current value for a current of an electrical system of the generator of the wind power installation.

6. The method according to claim 1, wherein the carrier signal is for setting a single-phase current of an electrical system of the generator the wind power installation.

7. The method according to claim 1, wherein the carrier signal is generated by a signal generator and has at least one of the following forms:
triangular;
sinusoidal; and
square-wave.

8. The method according to claim 1, wherein the actual value is an actual current value of the electrical system of the generator of the wind power installation.

9. The method according to claim 1, wherein the target value, the distortion variable, a compensation value are in d/q coordinates, and/or
the actual value is present in abc coordinates.

10. A method for controlling a wind power installation, comprising:
operating a converter of the wind power installation in an operating mode, wherein the converter is operated in the operating mode using the method according to claim 1.

11. A method for controlling a wind power installation, comprising:
operating a converter of the wind power installation in an operating mode, wherein the converter is operated in the operating mode using a database,
wherein the database comprises at least one predetermined parameter and/or a precalculated offset for the operating mode.

12. The method for controlling a wind power installation according to claim 11, wherein the at least one predetermined parameter and/or the precalculated offset are for a particular operating point of an active rectifier and/or the generator of the wind power installation.

13. The method for controlling a wind power installation according to claim 11, wherein the at least one predetermined parameter and/or the precalculated offset result in compensation for a generator current and/or an acoustic variable of the wind power installation.

14. The method according to claim 11, wherein the at least one predetermined parameter or the precalculated offset is taken into account when controlling the wind power installation only if:
the wind power installation has an acoustic variable above a predetermined limit value, and/or
the wind power installation controller specifies instructions to do so.

15. A wind power installation, comprising:
a converter; and
a controller,
wherein the converter is a power converter and is operated by the controller using the method according to claim 1.
